(19) United States
(12) Patent Application Publication
(10) Pub. No.: US 2001/0037509 A1
(43) Pub. Date: Nov. 1, 2001

(54) Hybrid wired/wireless video surveillance system

(76) Inventor: Joel Kligman, Toronto (CA)

Correspondence Address: Mark B. Eisen, Dimock Stratton Clarizio, Suite 3202, Box 102, 20 Queen Street West, Toronto, ON, M5H 3R3, CA

(21) Appl. No.: 09/866,671

(22) Filed: May 30, 2001

Related U.S. Application Data
(63) Continuation-in-part of application No. 09/558,224, filed on Apr. 26, 2000.

(30) Foreign Application Priority Data
Mar. 2, 2000 (CA) 2,299,897

(51) Int. Cl. H04N 7/18

(52) U.S. Cl. 725/105; 348/159; 348/143

(57) ABSTRACT

A closed circuit television (CCTV) observation system accommodates a video feed from one or more wireless camera/transmitters to a single monitor, which also provides inputs for wired cameras. In the preferred embodiment wireless receivers are implemented into a multi-channel monitor, so that either wired or wireless cameras may be used, depending upon the user's surveillance requirements and the availability of cable pathways at the installation location. To reduce interference the wireless receiver is disposed on the back cover of the monitor offset from the electron beam generator of the monitor and generally parallel to an optical axis of the electron beam. A video surveillance system according to the invention may incorporate different combinations of wired cameras and wireless cameras, and may sequence through real-time video images generated by the various wireless cameras while providing a display of multiple camera segments, so that by a combination of screen splitting and camera sequencing a single monitor can be used to efficiently monitor cameras in many different positions, in real-time. The monitor may be equipped with a video capture card, which outputs the video image displayed on the monitor to a processing appliance such as a personal computer or computer network via a computer-compatible interface.

This application is a continuation-in-part of application Ser. No. 09/558,224 filed Apr. 26, 2000, which is pending.

### FIELD OF INVENTION

This invention relates to closed circuit television (CCTV) observation systems. In particular, this invention relates to a CCTV system integrating a plurality of video cameras, at least one of which is a wireless camera, into a video monitor for closed circuit television surveillance of a premises or other location and optionally remote surveillance via a link to a global computer network.

### BACKGROUND OF THE INVENTION

CCTV observation systems are utilized by businesses, homeowners, institutions and others for the purpose of providing surveillance and security. These systems comprise video monitors receiving video signals from various types of video cameras. A typical CCTV observation system includes one or more video monitors, to each of which may be connected one or more video cameras.

In a wired CCTV system, the video cameras are connected by a cable to the monitor(s) or to an intervening device such as a switcher or multiplexer. The monitor of a CCTV system may provide an input for a single camera or several inputs (channels) for connecting several cameras. In the case of a multiple-channel system the monitor may incorporate a switcher to alternate the video feed between the various cameras, or may incorporate a device which allows the images of a plurality of wired cameras to be viewed on the monitor simultaneously, such as a “quad splitter” which multiplexes video feeds from multiple wired cameras and divides the viewing field of the monitor into a comparable number of smaller segments, each of which displays the video feed from a different camera. Up to four separate viewing segments have typically been provided in such systems.

Typically the installation of a wired CCTV observation system requires locating the video cameras in the desired positions and running a video cable to the desired monitor location (for example a security kiosk), or to a video processing device which is in turn coupled to the monitor. Where there is a clear path for the cable, such as in the case of a building under construction or where a drop ceiling is available, the CCTV observation system is installed relatively easily by a skilled technician and occasionally may be installed by the end user.

However, should the installation location not have a readily available path for the video cable, this task becomes considerably more difficult. Often one or more video cameras must be moved to a less advantageous location (from the surveillance perspective) in order to provide a path for the video cable. In such cases, considerable time and expense may be involved in relocating cameras and fishing wires through finished structures, or the field of surveillance may be substantially compromised and the security benefits of the system thereby considerably reduced.

Wireless observation systems are also known, which consist of either a monitor incorporating a wireless receiver, or an external wireless receiver connected to a wired system monitor. These monitors and receivers may be either single channel or multi-channel, and receive an rf signal (either digital or analogue) representing the video image received by the wireless video camera at any particular point in time. This allows for real time observation of the field of view of the camera(s) on the monitor. However, because the video signal is very data intensive, in order to provide real time surveillance in a wireless system the resolution of the image on the monitor is significantly lower than that of a wired system.

Conventional wireless CCTV observation systems do not provide connections for wired cameras. As a result, the higher resolution end performance available from wired cameras is not available in wireless CCTV surveillance systems. Moreover, wireless observation systems do not provide simultaneous multiple-field observation such as is available in wired CCTV systems incorporating a quad splitter, and the high data density of the wireless signal makes it difficult to incorporate the image from a wireless camera into a composite image of multiple viewing segments from wired cameras. Also, incorporating a wireless receiver into a monitor is problematic due to rf interference generated by other monitor circuits.

Such systems are also limited to the extent that the monitor provides a single primary site for surveillance, typically at or near the monitored premises in order to simplify cabling of wired cameras and remain within range of wireless cameras. Surveillance cannot be undertaken simultaneously from multiple sites, or from a remote site, without expensive additional networking equipment and/or cabling, much of which would be redundant based on the equipment at the primary surveillance site.

The present invention overcomes these disadvantages by providing a CCTV observation system which accommodates a video feed from one or more wireless camera/transmitters to a single monitor which incorporates one or more wireless receivers and also provides inputs for wired cameras. In the preferred embodiment, the one or more wireless receivers are implemented into a multi-channel monitor, so that the user may elect to utilize either wired or wireless cameras, depending upon the user's surveillance requirements and the availability of cable pathways at the installation location.

In the preferred embodiment the system of the invention utilizes a wireless communications data link, preferably in the 2.4 GHz frequency range, in conjunction with wired camera channels. The system of the invention may thus be easily adapted to installation situations where using only wired cameras is impractical, due to installation limitations, and using only wireless cameras is unsuitable because of the lesser resolution and/or slower refresh interval provided thereby. In the system of the invention installers and end users may select either wireless or wired cameras, as dictated by the circumstances of the installation.

In the preferred embodiment of the invention, the system of the invention provides a multi-channel monitor with an integrated signal splitter (e.g. quad splitter) and a wireless receiver. According to this embodiment, the signal from one or more wireless cameras may be received by the monitor and displayed on one of the monitor channels in both the single channel and quad mode. To achieve this, in the preferred embodiment the wireless receiver circuit board is mounted on the interior of the back cover of the monitor, offset from the electron beam generator of the cathode ray tube (CRT) and generally parallel to the optical axis of the electron beam in the CRT. The invention further accommodates systems which incorporate multiple video receivers and/or multi-channel receivers in a similar fashion, such that wireless signals may be received and viewed simultaneously on additional channels. Each wireless camera is preferably code-enabled, so that only an authorized receiver having the correct code can receive the wireless signal from each wireless camera.

The present invention further facilitates remote surveillance, and concurrent surveillance at multiple locations, by shunting the composite video image to a network card, for example a printed circuit board which is integrated into the monitor and connected to a wide area network communications system such as a telephone network. In this fashion the composite image exactly as displayed on the local monitor is simultaneously available to one or more remote monitors connecting through a suitable processing device, for example a personal computer (PC), at very little additional cost.

The present invention thus provides a closed circuit television observation system, comprising at least one wired video camera and at least one wireless video camera, at least one monitor having a plurality of channels, and at least one video port coupled to at least one channel for connection to the wired video camera, and a wireless receiver having at least one channel for receiving a video signal from the wireless video camera.

In further aspects of the invention: the wireless receiver has a plurality of channels for receiving video signals from a plurality of wireless cameras, comprising a sequencer for sequencing between images generated by the plurality of wireless cameras; the sequencer is integrated into the wireless receiver; the monitor comprises a quad splitter for dividing the monitor display into four segments, each segment displaying a video image corresponding to a different video camera; one of the segments displays a video image corresponding to a wireless camera, comprising switching a sequencer for sequentially switching the wireless receiver between images generated by the wireless cameras; the monitor comprises circuitry for outputting the video image displayed on the monitor to a processing appliance; the processing appliance is remote from the observation system; the processing appliance is part of a computer network; the observation system communicates with the computer network over a telephone line; the system is programmed to detect motion within one or more of the video images or a selected portion thereof, and in response to detected motion, to initiate a dial-up procedure to contact a person or connect the video output to a monitor at a remote location; the circuitry for outputting the video image is remotely addressable by an IP address; the circuitry for outputting the video image is associated with video streaming software; and/or the wireless receiver is disposed on a circuit board mounted on a back cover of the monitor offset from an electron beam generator of the monitor and generally parallel to an optical axis of the electron beam generator.

### BRIEF DESCRIPTION OF THE DRAWINGS

In drawings which illustrate by way of example only preferred embodiments of the invention,

FIGS. 1a, 1b and 1c are front, rear and side schematic views, respectively, of a hybrid wired/wireless CCTV observation system according to the invention,

FIGS. 2a and 2b are front and rear schematic views, respectively, of a four-channel system of the invention with sequential switching between video cameras,

FIGS. 3a and 3b are front and rear schematic views, respectively, of a four-channel system of the invention incorporating a quad splitter, and

FIGS. 4a and 4b are front and rear schematic views, respectively, of a further four-channel system of the invention incorporating a quad splitter.

### DETAILED DESCRIPTION OF THE INVENTION

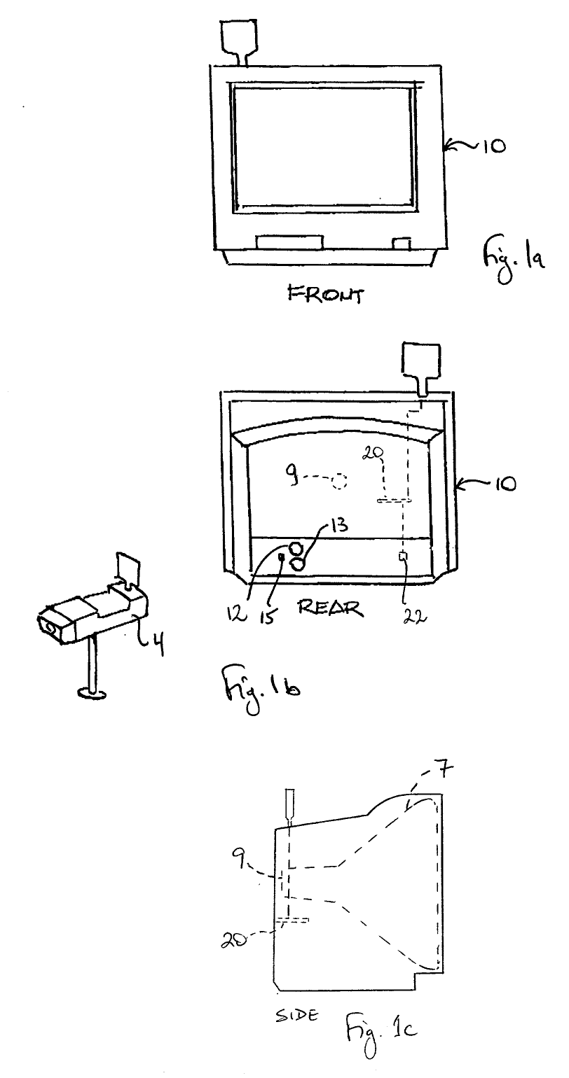

FIGS. 1a and 1b illustrate an embodiment of the invention utilizing a single-channel monitor 10 incorporating a two- or four-channel wireless receiver 20. A wired camera 2 may be connected to the monitor 10 through the video port 12 and optional audio port 13. When a video cable is connected to the video port 12, the camera select switch 15 is switched to the ‘wired’ position to disconnect the wireless receiver 20 from the video feed, and the monitor 10 displays an image representing the field of view of the camera 2. Alternatively, with the camera select switch 15 in the ‘wireless’ position the wireless receiver 20 is coupled to the video feed, and the monitor 10 displays an image representing the field of view of a selected wireless camera 4.

Thus, the incorporation into the monitor 10 of a wireless receiver 20 allows the signal received from multiple wireless cameras 4 to be processed into a channel of the video monitor 10, and seamlessly integrated with the images from wired cameras 2. To ensure that the video signal from the wireless camera 4 cannot be intercepted, the receiver 20 is programmed with a code corresponding to each wireless camera 4, so that only an authorized receiver having the correct code can receive the wireless signal from each wireless camera.

In one embodiment the wireless camera 4 is selected by an externally accessible switch 22, which controls a tuner in a multi-channel receiver 20. Each wireless camera 4 is assigned a frequency within the bandwidth of the receiver 20, and the position of the switch 22 determines the frequency to which the receiver is tuned for the video feed to the monitor 10. In this embodiment the monitor provides a single viewing segment, for the wired camera 2 or the selected one of the wireless cameras 4. In a further embodiment the receiver contains an internal sequencing switch (not shown) which sequences through the wireless channels to sequentially display the images from different cameras 4 on the monitor 10. In either case the receiver 20 can sequence through the plurality of wireless cameras 4 and process the signal from any selected camera 4 through a single video input channel of the monitor 10. This increases the camera capacity of the monitor 10 while utilizing only a single monitor channel.

As shown in FIGS. 1b and 1c, the wireless receiver circuit board 20 is mounted on the interior of the back cover 10a of the monitor 10, offset from the electron beam generator 9 of the CRT 7 and generally horizontally, i.e. parallel to the optical axis of the electron beam in the CRT 7. This minimizes the effects of ambient rf interference produced by other monitor circuitry, including the CRT electron gun 9, and allows the wireless receiver 20 to maintain a practical receiving range for the wireless cameras 4 without disruption or degradation of the image from the wireless camera 4.

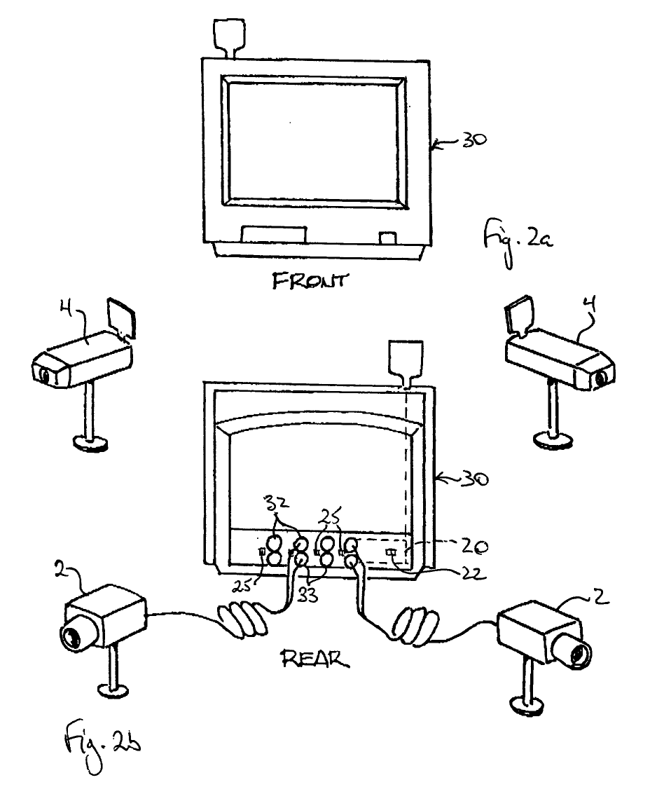

FIG. 2 illustrates an embodiment of the invention utilizing a four-channel monitor 30 with sequential switching between channels. Each channel may accommodate either a wired camera 2 or a wireless camera 4 through video ports 32 and optional audio ports 33. In this embodiment the monitor 30 displays a single image corresponding to one of the cameras 2 or 4, selected by camera select switches 25 and receiver switch 22, or alternatively by an internal sequencing switch (not shown) which sequences through the wired and wireless channels to sequentially display the images from different cameras 2 and 4 on the monitor 30.

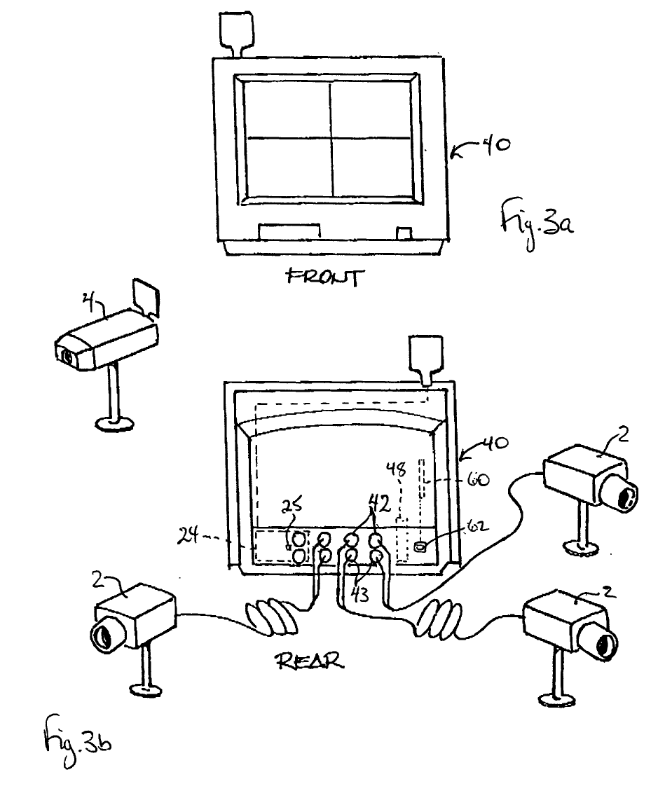

FIG. 3 illustrates an embodiment of the invention utilizing a four-channel monitor 40, with an integrated quad splitter 48 which divides the display into four segments, each corresponding to a channel of the monitor 40. The monitor 40 accommodates three wired cameras 2 and comprises a single-channel wireless receiver 24 which receives an image from a wireless camera 4. The monitor 40 display thus incorporates four separate images, divided as shown in FIG. 3a, to thus simultaneously provide multiple surveillance fields.

In the embodiment of FIG. 3 the wireless receiver 24 may alternatively be provided with multiple channels (frequencies) for receiving signals from multiple wireless video cameras 4, and the wireless camera 4 displayed on the monitor 40 is selected by a tuner switch or an internal sequencing switch (not shown) as in the previous embodiments. Each wireless camera 4 is assigned a frequency within the bandwidth of the receiver 20, and the position of the tuner switch determines the frequency to which the receiver is tuned for the video feed to the monitor 10. The video image from the selected wireless camera 4 is displayed in the monitor segment corresponding to the wireless channel, and the receiver 24 may sequence through the wireless cameras 4, displaying a real-time or intermittent video image from each wireless camera 4 in turn in the monitor segment corresponding to the wireless channel.

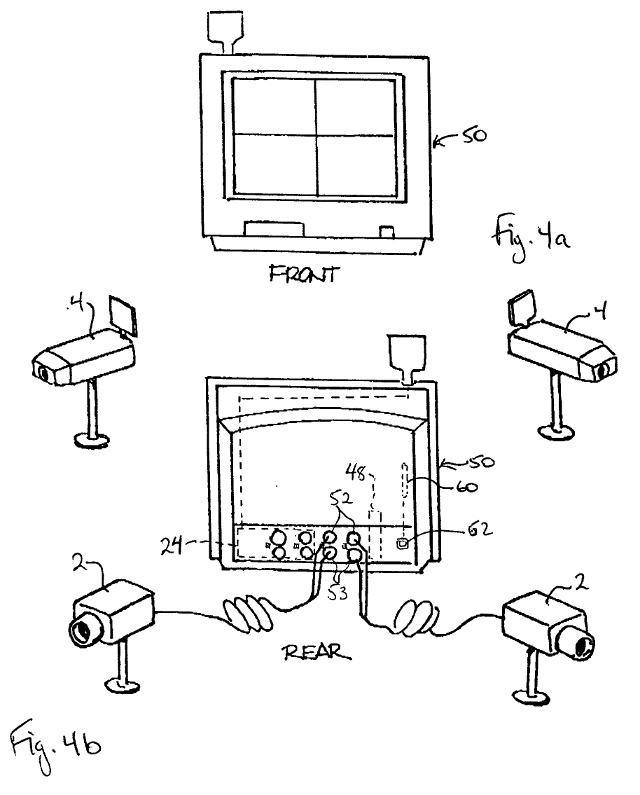

FIG. 4 illustrates a further embodiment of the invention utilizing a four-channel monitor 50 having video ports 52 and optional audio ports 53, with an integrated quad splitter 48 to divide the display into four segments, each corresponding to a channel of the monitor 50. The monitor 50 accommodates two wired cameras 2 and comprises a two-channel wireless receiver 24 which receives images from up to two wireless cameras 4. The monitor 50 display thus incorporates four separate images, segmented as shown in FIG. 4a, to thus simultaneously provide multiple surveillance fields.

In the quad splitter embodiments the video image from each selected wireless camera 4 is displayed in the monitor segment corresponding to the wireless channel to which the receiver 24 is connected, and the receiver 24 may sequence through the wireless cameras 4 to display a real-time video image from each wireless camera 4 in turn. The wireless cameras 4 may also be combined with one or more wired cameras 2 to generate a composite image consisting of a combination of the viewing fields of the various cameras 2, 4. The sequencer can refresh the video images at a rate suitable for maintaining the highest possible resolution of the image from a wireless video camera 2, for example 15 frames per second.

In these embodiments a wireless video signal receiver/multiplexer (not shown) which accommodates up to four wireless video cameras may be utilized in conjunction with the wired camera channels, so long as the wireless channel frequencies do not interfere with the wireless channel frequency or frequencies of the wireless receiver integrated into the monitor. Also, a plurality of single-channel wireless receivers may be used instead of a multi-channel wireless receiver 24.

Thus, a video surveillance system according to the invention may incorporate different combinations of wired cameras 2 and wireless cameras 4. In the case of wireless monitor channels the invention may sequence through real-time video images generated by the various wireless cameras 4, while providing a display of multiple camera segments, so that by a combination of screen splitting and camera sequencing a single monitor can be used to efficiently monitor cameras 2, 4 in many different positions, either in real-time or intermittently through known video sampling and storage techniques.

Each of the described embodiments may be implemented with a “video capture” card 60 (shown in FIGS. 3 and 4), which outputs the video image displayed on the monitor, for example through universal serial bus (USB) port 62 and a USB cable, or any other compatible interface, to a processing appliance such as a personal computer (not shown). The video capture card 60 is preferably integrated into the monitor 40, and may be connected to a stand-alone computer or, to facilitate both remote surveillance and concurrent surveillance at multiple locations, in pier-to-pier (PTP) fashion to another computer; to a local area network (LAN), for example using Ethernet or any other suitable communications protocol; or to a wide area network (WAN), for example over a telephone network to a global computer network such as the Internet. The video capture card 60 may communicate using any suitable modem type and/or by wireless communication techniques.

The composite video image is shunted directly to the video capture card 60, which thus outputs the composite video image to the personal computer, or over the LAN or WAN. Since the image transmitted by the video capture card is the post-processed composite video image, all image segments are viewed at the remote station in real time, and exactly as they are displayed on the local monitor 40. In this fashion the composite image exactly as displayed on the local monitor 40 is simultaneously available to one or more remote stations connecting through any suitable processing device.

Where the video capture card 60 is connected to the Internet, the video capture card 60 may be hard-coded with an Internet Protocol (IP) address, or programmed to be assigned a floating IP address by the service provider's Internet server. Appropriate security software may be implemented to permit only authorized connection to the monitor 40, and streaming of the composite video image may be effected by any suitable video streaming software.

The computer may also be programmed in known fashion to detect motion within one or more of the images, or in any selected portion of one or more of the images, and in response thereto initiate a dial-up procedure to call a contact person or connect the video feed to a monitor at a remote location, actuate an alarm (either local or remotely monitored, or both), and record the displayed images (either continuously or intermittently) for a selected duration following the event recorded by the computer.

Although various preferred embodiments of the present invention have been described herein in detail, it will be appreciated by those skilled in the art, that variations may be made thereto without departing from the spirit of the invention or the scope of the appended claims.

I claim:

1. A closed circuit television observation system, comprising
at least one wired video camera and at least one wireless video camera,
at least one monitor having a plurality of channels, and at least one video port coupled to at least one channel for connection to the wired video camera, and
a wireless receiver having at least one channel for receiving a video signal from the wireless video camera.

2. The closed circuit television observation system of claim 1 in which the wireless receiver has a plurality of channels for receiving video signals from a plurality of wireless cameras, comprising a sequencer for sequencing between images generated by the plurality of wireless cameras.

3. The closed circuit television observation system of claim 2 in which the sequencer is integrated into the wireless receiver.

4. The closed circuit television observation system of claim 2 in which the monitor comprises a quad splitter for dividing the monitor display into four segments, each segment displaying a video image corresponding to a different video camera.

5. The closed circuit television observation system of claim 4 in which one of the segments displays a video image corresponding to a wireless camera, comprising switching a sequencer for sequentially switching the wireless receiver between images generated by the wireless cameras.

6. The closed circuit television observation system of claim 4 in which the monitor comprises circuitry for outputting the video image displayed on the monitor to a processing appliance.

7. The closed circuit television observation system of claim 6 in which the processing appliance is remote from the observation system.

8. The closed circuit television observation system of claim 7 in which the processing appliance is part of a computer network.

9. The closed circuit television observation system of claim 8 in which the observation system communicates with the computer network over a telephone line.

10. The closed circuit television observation system of claim 9 in which the system is programmed to detect motion within one or more of the video images or a selected portion thereof, and in response to detected motion, to initiate a dial-up procedure to contact a person or connect the video output to a monitor at a remote location.

11. The closed circuit television observation system of claim 9 in which the circuitry for outputting the video image is remotely addressable by an IP address.

12. The closed circuit television observation system of claim 11 in which the circuitry for outputting the video image is associated with video streaming software.

13. The closed circuit television observation system of claim 1 in which the wireless receiver is disposed on a circuit board mounted on a back cover of the monitor offset from an electron beam generator of the monitor and generally parallel to an optical axis of the electron beam generator.
